(19) United States
(12) Patent Application Publication
(10) Pub. No.: US 2011/0186679 A1
(43) Pub. Date: Aug. 4, 2011

(54) AIRCRAFT WITH AT LEAST TWO PROPELLER DRIVES ARRANGED AT A DISTANCE FROM ONE ANOTHER IN THE SPAN WIDTH DIRECTION OF THE WINGS

(76) Inventor: Daniel Reckzeh, Stuhr (DE)

(21) Appl. No.: 13/003,501

(22) PCT Filed: Jul. 13, 2009
(86) PCT No.: PCT/EP09/05083

§ 371 Date: Jan. 31, 2011

(30) Foreign Application Priority Data
Jul. 11, 2008 (DE) 102008032789.1
Jul. 11, 2008 (US) 61/080026

(51) Int. Cl. B64D 27/02

(52) U.S. Cl. 244/65

(57) ABSTRACT

An aircraft with a fuselage and two aerodynamic wings, which each accommodate at least two propeller drives spaced a apart from each other in the wingspan direction, each with a propeller rotational axis, wherein the aircraft has a controller for activating the propeller drives, wherein in one operating mode of the controller for generating propulsion, the propeller drives are activated in such a way that the outer section of a propeller secured to the respective propeller rotational axis is moved from the top down on the side facing the fuselage.

The invention relates to an aircraft, the aerodynamic wings of which each have at least two drive engines spaced apart from each other in their wingspan direction, each with a propeller rotational axis.

In such aircraft having at least two drive engines that are spaced apart from each other in their wingspan direction and each have a propeller rotational axis, the complexity of the aerodynamic effects generated by the individual engines combined with aircraft-related considerations rule out the special configuration criteria for twin-engine aircraft.

Known from the general prior art are transport aircraft with a total of at least two propeller drives on each wing, in which the propeller drives 11, 12, 13, 14 are set up on FIG. 2 in such a way that their propeller rotational axes 11a, 12a, 13a, 14a turn in the same rotational direction to generate a propulsive force for the aircraft 1. In the depiction on FIG. 2, the arrows diagrammatically indicate the rotational direction of the propeller rotational axes 11a, 12a, 13a, 14a to generate a propulsive force for the aircraft 1. The rotational directions of the propeller rotational axes 11a, 12a, 13a, 14a provided for propulsion purposes are not optimal from the standpoint of aerodynamics and control engineering, since the propellers create asymmetrical aerodynamic effects in relation to the longitudinal axis of the fuselage 3 given these rotational directions, which must be compensated by corresponding positioning motions of the flaps, and these positioning motions must be introduced in addition to those positioning motions required for control purposes. Despite this fact, the propeller drives are usually realized with the propulsion rotational directions shown on FIG. 2, since all drives on the wing 5a, 5b can be realized with the same components and subsystems, e.g., the same engine, the same gearing, and the same propellers, so that this solution yields major logistical, and hence cost, advantages. In light of these logistical advantages, the manufacturing costs for the drives as a whole can be reduced, as can the servicing and maintenance of components and subsystems.

The rotational directions of the propellers for a propeller-driven aircraft 1 can further be determined based on the cruising configuration, doing without the aforementioned logistical advantages. In addition, the two propeller rotational directions depicted on FIGS. 3 and 4 are generally also possible for the propulsion of the aircraft 1. Provided here first and foremost is the arrangement of the propeller rotational directions depicted on FIG. 3, which is symmetrical relative to the longitudinal fuselage direction, since this configuration is favorable for cruising with respect to the aerodynamic layout, and also favorable in terms of control technology given the symmetrical arrangement of the propeller rotational directions, since the flap motions need not perform any additional compensatory motions to offset asymmetrically arising aerodynamic effects. Since the aircraft with these propeller drive rotational directions is advantageous from both an aerodynamic and control technology standpoint, prior art uses this arrangement as an alternative to the arrangement of propeller rotational directions according to FIG. 2 in cases where special significance need not be placed on reducing costs through the communality of propeller drives 11, 12, 13, 14.

Theoretically, the arrangement of propeller rotational directions according to FIG. 4 can also be considered. In this arrangement, there is also no communality of structural design among the four propeller drives. In addition, the aerodynamic configuration in such an arrangement of propeller rotational directions is less favorable in terms of cruising than the arrangement according to FIG. 3, but this arrangement yields better slow flight properties for the aircraft 1 than the arrangement according to FIG. 3. In addition, this arrangement of propeller rotational directions is advantageous from the standpoint of control technology given the symmetrical arrangement of propeller rotational directions. Another advantage of the arrangement of propeller rotational directions according to FIG. 4 by comparison to the arrangement on FIG. 3 is that the noise penetrating into the fuselage is low, since given an upward motion of the end propeller sections of the propellers of the propeller drives 12, 13 lying on the inside, i.e., next to the fuselage, less turbulence emanates from the propeller in the region between these propeller drives 12, 13 and the fuselage than if the propeller rotational directions were arranged in such a way that the propeller end pieces of the inner propeller drives 12, 13 move down in the region between the latter and the fuselage, for example as shown on FIG. 2. In special individual cases, these advantages can be weighted in such a way as to prefer the configuration on FIG. 4 to the other configurations, which offer a communality of drives.

The object of the invention is to find alternative aircraft configurations making it possible to realize an optimal, complete aircraft.

This object is achieved with the features of claim 1. Additional embodiments are indicated in the subclaims that relate back to the latter.

Both wings of the aircraft provided according to the invention have at least two propeller drives spaced apart from each other in the wingspan direction, each with a propeller rotational axis, wherein the controller is designed in such a way that the outer section of a propeller secured to the respective propeller rotational axis is moved from the top down on the side facing the fuselage.

When arranging the propeller drives spaced apart from each other in the wingspan direction on each wing of the aircraft according to the invention, it can be provided in particular that the first propeller drive lying closer to the fuselage be situated on one respective wing within a wingspan range of between 15 and 40%, while the outer propeller drive is located in the wingspan range of between 40 and 80%, wherein the wingspan direction proceeding from the fuselage is defined, and the outer wing tip is situated at a point defined by 100% of the wingspan.

In another embodiment of the invention, each propeller drive has a single propeller disk on one and the same propeller rotational axis.

In another exemplary embodiment, it can be provided that the propeller disks cover at least 30% of the wingspan.

The invention can provide that the wings of the aircraft form an angle of sweep-back of between +10 degrees and +40 degrees.

Alternatively or additionally, the invention can provide that the propeller disks cover at least 50% of the wingspan.

In another exemplary embodiment, the aircraft can be designed in such a way that the location of the propeller disks coming closest to the leading wing edge have a local distance of at least 5% of the local wing chord to the leading wing edge that arises locally, i.e., at this location.

In another exemplary embodiment, the aircraft can be designed in such a way that the distance or misalignment of the propeller rotational axis on the propeller hub or the misalignment of the propeller rotational axis where it intersect the plane defined by the propeller disks measures at most 30% of the propeller diameter from the top down viewed toward the leading airfoil in the vertical plane of the aircraft.

The invention will be described based on the following figures:

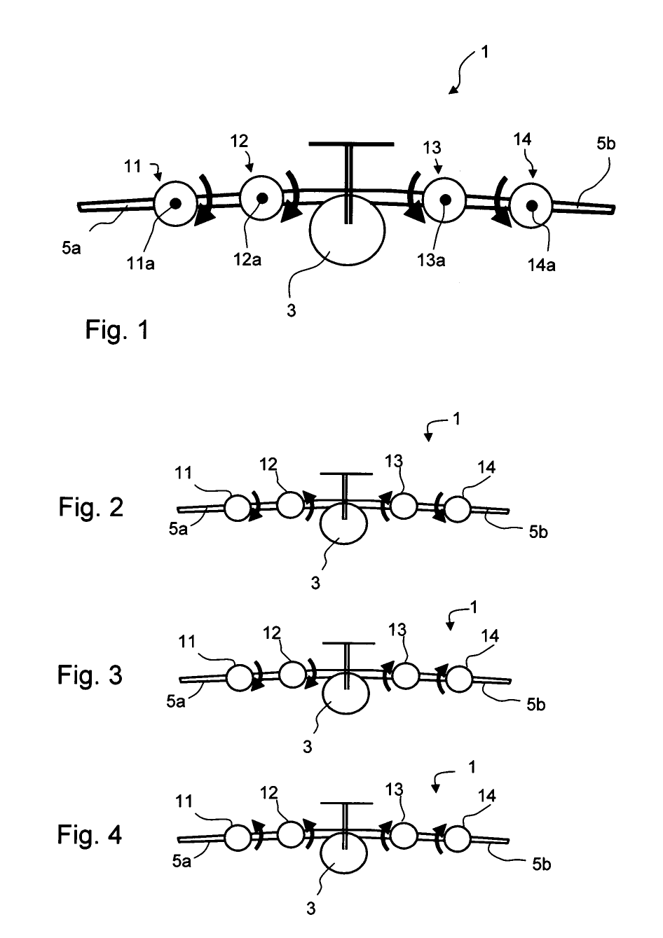

FIG. 1 shows a diagrammatic view of the aircraft with the configuration of the propeller rotational directions according to the invention;

FIG. 2 shows a diagrammatic view of an aircraft with a configuration of the propeller rotational directions known from the general prior art;

FIG. 3 shows a diagrammatic view of an aircraft with a configuration of the propeller rotational directions known from the general prior art;

FIG. 4 shows a diagrammatic view of an aircraft with another possible configuration of the propeller rotational directions.

These figures use arrows to depict the respectively provided rotational direction of the propellers. In the figures, components or parts of the depicted aircraft with the identical or similar function are provided with the same reference numbers.

FIG. 1 shows an aircraft with a fuselage 3 and two aerodynamic wings 5a, 5b, which accommodates at least two respective propeller drives 11, 12, 13, 14 spaced apart from each other in the wingspan direction, each having a propeller rotational axis 11a, 12a, 13a, 14a. A propeller (not shown) is secured to the rotational axes 11a, 12a, 13a, 14a. The propeller drives 11, 12, 13, 14 are activated from a controller for activating the propeller drive engines.

The controller and propeller drives 11, 12, 13, 14 are designed in such a way that, in one operating mode of the controller for generating propulsion, the propeller drive engines are activated in such a way that the outer section of a propeller respectively secured to the respective propeller axis is moved from the top down on the side facing the fuselage (FIG. 1). The operating mode of the controller for generating propulsion is the operating mode in which the aircraft is operated in the air.

Therefore, the invention provides an aircraft 1 with a fuselage 3 and two aerodynamic wings, which accommodate a respective at least two propeller drives 11, 12, 13, 14 spaced apart from each other in the wingspan direction, each with a propeller rotational axis 11a, 12a, 13a, 14a, wherein the aircraft 1 has a controller for activating the propeller drives 11, 12, 13, 14. In an operating mode of the controller for generating propulsion, the propeller drives 11, 12, 13, 14 are activated in such a way that the outer section of a propeller respectively secured to the respective propeller rotational axis is moved from the top down on the side facing the fuselage 3.

In particular, this can be a fixed-wing aircraft. In particular, the aircraft according to the invention can be designed as a high wing aircraft.

In addition, the invention can provided that the controller and propeller drives 11, 12, 13, 14 are set up in such a way that each propeller rotational axis 11a, 12a, 13a, 14a can also be moved in a rotational direction in which the propeller secured to the respective propeller rotational axis 11a, 12a, 13a, 14a is moved from the bottom up on the side facing the fuselage 3.

In these embodiments, it can alternatively or additionally be provided according to the invention that the controller and propeller drives 11, 12, 13, 14 are set up in such a way that two propeller drives 11, 12, 13, 14 respectively lying symmetrically to each other relative to the longitudinal fuselage axis can be moved in one rotational direction, in which the propeller respectively secured to the respective propeller rotational axis is moved from the bottom up on the side facing the fuselage 3, while the other propeller drives 11, 12, 13, 14 are activated in such a way that the outer section of a propeller respectively secured to the respective propeller axis is moved from the top down on the side facing the fuselage 3.

The arrangement of propeller rotational directions according to FIG. 1 is unfavorable with regard to the cruising layout of the aircraft 1, since this configuration generates a greater flow resistance arising due to overlapping wake flows of the propeller of the inner lying propeller drives 12, 13 and the wings 5a, 5b. Further, the propeller drives 11, 12, 13, 14 also offer no communality advantages given an arrangement of propeller rotational directions according to FIG. 1. This configuration of propeller rotational directions is also unfavorable with regard to the noise introduced into the aircraft fuselage, wherein a configuration of the propeller rotational directions according to FIG. 2 or 4 would be advantageous.

For this reason, the configuration of the propeller rotational directions according to the invention is not known from prior art.

Contrary to expectations, the configuration of propeller rotational directions according to FIG. 1 results in a situation where the flow on the wing in the wake of the propeller of the inner laying propeller drive 12, 13 only separates at greater angles of attack than for the configuration of the propeller rotational directions according to FIG. 2 owing to interferences between this propeller and the airfoil. This makes it possible to achieve a greater maximum lift for the aircraft 1. According to the invention, this special advantage results in a configuration of the propeller rotational directions according to FIG. 1, wherein this configuration for the aircraft 1 enables the provision of a simpler high-lift system along with a smaller wing 5a, 5b for achieving a corresponding performance spectrum. As a consequence, the wings with the accompanying high-lift system can be realized more cost effectively. In addition, the wing with the accompanying high-lift system can be realized with a lower weight, so that the aircraft 1 can also be realized more favorably with regard to its flight performance.

Another factor is that rotational directions provided according to the invention yield a propeller having an improved control efficiency for the outer control surfaces of the airfoil on the fuselage side from the top down in the outer region of the airfoil as well, in particular with respect to the aileron. This stems from the fact that the air flow generated by the outer propellers interferes with the aerodynamic effect of the mentioned control surfaces, thereby additionally improving control effectiveness with respect to the outer control surfaces, in particular the aileron. In combination with the mentioned advantages resulting from the air flow generated by the inner lying propeller drives, this advantage makes the solution according to the invention especially advantageous aerodynamically both while cruising and during takeoff and landing, meaning also during slow flight, when compared to the solutions known from prior art.

According to the invention, the configuration of the propeller rotational directions according to FIG. 1 can be provided for high wing aircraft as well as middle or low wing aircraft, and here in particular for transport aircraft.

The mentioned disadvantages are encountered for propeller rotational directions arranged according to FIG. 1. However, these disadvantages are compensated by the corresponding design of the wings and high lift system, meaning by the unexpected advantages of the aircraft configuration in its entirety. The special advantages of the configuration of propeller rotational directions according to FIG. 1 provided according to the invention are achieved in particular given the following parameters for the aircraft 1:

The propeller engines are realized with a single propeller disk on the propeller rotational axis 11a, 12a, 13a, 14a, i.e., there is no multiple layout of propeller disks one in back of the other on one of the propeller rotational axes 11a, 12a, 13a, 14a (“contra-rotating props”).

The airfoil 5a, 5b can basically exhibit an angle of sweep-back ranging from −40° to +40°. However, it is particularly advantageous for the configuration of the propeller rotational directions according to the invention as depicted on FIG. 1 to have an angle of sweep-back of the wing measuring between +10 degrees and +40 degrees. As a result, the cruising range of the aircraft can lie in a higher flight velocity range, despite the elevated flow resistance that arises given a configuration of the propeller rotational directions according to the invention. According to the invention, this range of the angle of sweep-back is provided in particular with a single propeller disk or single or multiple propellers on one and the same propeller rotational axis 11a, 12a, 13a, 14a.

In this conjunction, the term angle of sweep-back proceeds from conventional definitions, and can in particular be the angle viewed from the top between the leading edge of the wings 5a, 5b relative to the flow arising as intended or to the transverse axis of the aircraft 1.

Alternatively or additionally to the mentioned embodiments, the effect according to the invention is already encountered if the propeller streams sweep over at least 30% of the wingspan width or the propeller disks cover at least 30% of the wingspan width viewed from the front. However, if the propeller streams sweep over at least 50% of the wingspan width or the propeller disks cover at least 50% of the wingspan width of the wings, the configuration according to the invention can be realized in an especially favorable manner. This coverage of the wing can advantageously be provided over up to 70% of the span, and in special individual cases, even more than that.

According to the invention, the propeller disks are arranged in front of the airfoil 5a, 5b. The propeller drives 11, 12, 13, 14 are here designed in such a way in one exemplary embodiment according to the invention that the propeller disks have a local distance of at least 5% of the wing chord arising at this location to the leading edge of the wings at the location where the latter come closest to the leading edge of the wings. This local distance can measure at most 70% of the local wing chord arising at this location to the leading edge of the wing.

The propeller rotational axes 11a, 12a, 13a, 14a can lie above or below the wing. In one exemplary embodiment according to the invention, the distance or misalignment of the propeller rotational axis at the propeller hub or the misalignment of the propeller rotational axis at the location where the latter intersect the plane defined by the propeller disks viewed toward the leading edge of the airfoil in the vertical plane of the aircraft measures at most 30% above or below the propeller diameter.

In another exemplary embodiment, the distance between the propeller tips of the propeller disks of the engines relative to each other measures at least 5% of the wingspan. This prevents the boundary vortexes emanating from the propellers from triggering any disruptive interference.

In another exemplary embodiment, the distance between the propeller tips of the inner engine relative to the outside of the fuselage measures at least 10%, and at most 80%, of the propeller diameter.

In the mentioned embodiments, the aircraft according to the invention preferably operates with cruising speeds in the subsonic range of over 0.6 mach, and up to at most 0.85 mach.

1. An aircraft, comprising:
a fuselage;
two aerodynamic wings, which each accommodate at least two propeller drives spaced a apart from each other in a wingspan direction, each with a propeller rotational axis; and
a controller for activating the propeller drives,
wherein the wings of the aircraft form an angle of sweep-back of sweep-back of between +10 degrees and +40 degrees, and
wherein, in one operating mode of the controller for generating propulsion, the propeller drives are activated in such a way that the outer section of a propeller secured to the respective propeller rotational axis is moved from the top down on the side facing the fuselage.

2. The aircraft according to claim 1, wherein each propeller drive has a single propeller disk on one and the same propeller rotational axis.

3. The aircraft according to claim 1, wherein the propeller disks cover at least 30% of the wingspan width.

4. (canceled)

5. The aircraft according to claim 1, wherein the propeller disks cover at least 50% of the wingspan width.

6. The aircraft according to claim 1, wherein the propeller disks have a local distance of at least 5% of the local wing chord relative to the leading edge of the wings at the location where the latter come closest to the leading edge of the wings.

7. The aircraft according to claim 1, wherein the distance of the propeller rotational axis at the location where the latter intersect the plane defined by the propeller disks viewed toward the leading edge of the airfoil in the vertical plane of the aircraft measures at most 30% above or below the propeller diameter.

8. The aircraft according to claim 1, wherein the controller and propeller drives are set up in such a way that each propeller rotational axis can also be moved in a rotational direction in which the propeller secured to the respective propeller rotational axis is moved from the bottom up on the side facing the fuselage.

9. The aircraft according to claim 1, wherein the controller and propeller drives are set up in such a way that two propeller drives respectively lying symmetrically to each other relative to the longitudinal fuselage axis can be moved in one rotational direction, in which the propeller respectively secured to the respective propeller rotational axis is moved from the bottom up on the side facing the fuselage, while the other propeller drives are activated in such a way that the outer section of a propeller respectively secured to the respective propeller axis is moved from the top down on the side facing the fuselage.
